(19) United States
(12) Patent Application Publication
(10) Pub. No.: US 2002/0094509 A1
(43) Pub. Date: Jul. 18, 2002

(54) Method and system for digital occlusal determination

(76) Inventors: Duane Durbin, San Diego, CA (US); Dennis Durbin, Solana Beach, CA (US)

Correspondence Address: Duane Durbin, 7660 Norcanyon Way, San Diego, CA, 92126, US

(21) Appl. No.: 09/726,833

(22) Filed: Nov. 30, 2000

(51) Int. Cl. A61C 11/00

(52) U.S. Cl. 433/213; 433/215

(57) ABSTRACT

Systems and methods for integrating bite registration data with a digital model of an upper jaw and a lower jaw includes determining one or more features on the bite registration data and the digital model; correlating features on the upper and lower jaws with features on the bite registration data; and aligning the digital model of the upper and lower jaws.

### BACKGROUND

The present invention relates to methods and systems for determining occlusion.

In many dental applications, a working model of a patient's teeth is needed that faithfully reproduces the patient's teeth and other dental structures, including the jaw structure. The model is typically created by first taking an impression of both the upper and lower jaws using an impression material such as alginate or polyvinylsiloxane (PVS). Once the impressions have set, a plaster or stone compound is poured into each of the impression trays to create the models for both the upper and lower jaws. Because the physical models are made using a separate impression tray for the upper and lower jaw impressions there is not an absolute way of determining the complete jaw alignment from just the cast upper and lower jaw models.

Conventionally, to determine the proper occlusal relationship between the teeth on the upper and lower jaws, a wax bite is typically taken. The determination of teeth occlusion such as bite registration has conventionally been a trial and error process. In determining bite registration, impressions and measurements on a patient's teeth and jaw may be made with articulation paper, plaster, wax, and pressure indicator paste, among others. The most common approach typically conforms the paste, plaster, or wax to an arch shape and positions the wax intra-orally between a patient's upper and lower dental arches. For example, a wax bite can be obtained by inserting a thin sheet of wax into the patient's mouth and having them bite down on the wax thus leaving a bite mark on both sides of the wax sheet. The dentist can then use the wax bite impression to align the upper jaw model into its wax bite marks while also aligning the lower jaw model into its wax bite marks. With both jaw models aligned in their corresponding wax bite marks, the dentist can directly view the correct full occlusion position of the jaws. This alignment technique may be used to place corresponding marks or surfaces on the upper and lower jaw models to facilitate viewing the aligned models at a future time without the need to re-align with the wax bite.

While wax is commonly used for bite registration, potential problems with wax includes the propensity for wax to warp, bend, and/or become brittle, depending on how the wax is handled, stored, and used. If the wax impression is compromised, the patient's dentist or dental provider may need to retake the entire set of measurement and the patient's treatment may need to be completely revised based on the retake.

Currently, systems have been developed (e.g. OrthoCad) which allow the physical study models and the wax bite impression to be digitized and integrated into a 3D image that shows the proper occlusal alignment. Other systems, which focus solely on occlusion, have been developed to provide a diagnostic tool for occlusal analysis. One such system (Tekscan's T-Scan II) uses a matrix based pressure-sensing array to measure both biting time profiles and forces and provides a graphical indication of the patient's occlusal force deviation from a “normal” occlusal force balance.

Recently, U.S. patent application titled METHOD AND SYSTEM FOR IMAGING AND MODELING DENTAL STRUCTURES filed on Oct. 25, 2000 by Duane M. Durbin and Dennis A. Durbin discloses a method and apparatus for mapping the structure and topography of dental formations such as periodontium and teeth, both intact and prepared, for diagnosis and dental prosthetics and bridgework by using an intra-oral image scanning technique. When digital 3D models of the upper and lower jaws are created, by utilizing such an intra oral scanning system, the bite registration of the upper and lower jaws is not measured since the scanning must take place with the jaws partially open. Existing methods of aligning the jaws, such as a wax bite, are not directly applicable for these direct to digital jaw models.

### SUMMARY

In one aspect, a method for integrating bite registration data with a digital model of an upper jaw and a lower jaw includes determining one or more features on the bite registration data and the digital model; correlating features on the upper and lower jaws with features on the bite registration data; and aligning the digital model of the upper and lower jaws.

Implementations of the above aspect may include one or more of the following. The bite registration data can be used to show a partial occlusion or a full occlusion. The digital model can represent partial jaws or full jaws. The features include points on the jaws and the bite registration data. A digital model may be constructed for the upper and lower jaws. A digital bite model may be constructed by biting into an array of sensors. The construction of the digital bite model may include capturing images of upper and lower jaw dental structures with the jaws closed.

In another aspect, a system for integrating bite registration data with a digital model of an upper jaw and a lower jaw includes means for determining one or more features on the bite registration data and the digital model; means for correlating features on the upper and lower jaws with features on the bite registration data; and means for aligning the digital model of the upper and lower jaws.

Advantages of the system may include one or more of the following. The invention captures a digital occlusal (bite) impression for use in the determination of the correct positioning of the upper and lower jaws for both digital and physical dental models. The digital bite impression when used in conjunction with dental models of the upper and lower jaw would have application in dental diagnosis and for the specification and manufacture of dental prosthetics such as bridgeworks, crowns or other precision moldings and fabrications. In addition, it would have utility in the diagnosis and treatment planning process for dental malocclusions. The system would allow the data representing an occlusal impression to be transmitted electronically to support activity such as professional consults, insurance provider reviews, and the impression may be electronically archived for future reference.

The system provides an accurate bite registration analysis, therefore ensuring a higher quality result. Occlusal forces affecting bite registration can be captured by having a patient bite down on a sensor pad. The system automatically digitizes and analyzes the bite registration information, and displays the information for review. The system eliminates complex and time-consuming steps previously required to make bite registration impressions. The system enables the dentist or an in-office assistant to quickly and easily create high-quality and durable bite registration information for treating the patient.

The foregoing, along with further features, advantages, and benefits of the invention, will be seen in the following detailed description of a presently preferred embodiment representing the best mode contemplated at this time for carrying out the invention. The description will refer to accompanying drawings as follows.

### BRIEF DESCRIPTION OF THE DRAWINGS

FIG. 1 shows one embodiment of a process utilizing digital 3D dental models and a digital bite model to determine bite registration between the upper and lower jaw 3D models.

FIG. 2A and 2B show exemplary digital 3D dental models of the upper and lower jaws created from separate scans of each jaw with the jaw in an open position.

FIG. 3 shows a third 3D model created from a scan of the dental structure with the jaw in a closed position.

FIG. 4 is an exemplary process to determine the alignment of the upper and lower jaw 3D models for the closed jaw position.

FIG. 5 illustrates an exemplary alignment of the coordinate reference frame for the upper and lower 3D models.

FIG. 6 shows an exemplary occlusal bite array sensor.

FIG. 7 shows a second embodiment of an alignment process using the sensor of FIG. 6.

FIG. 8 shows a second embodiment of the sensor of FIG. 6.

FIG. 9 illustrates an embodiment of a system for performing intra-oral scanning and for generating 3D models of teeth and other dental structures.

### DETAILED DESCRIPTION

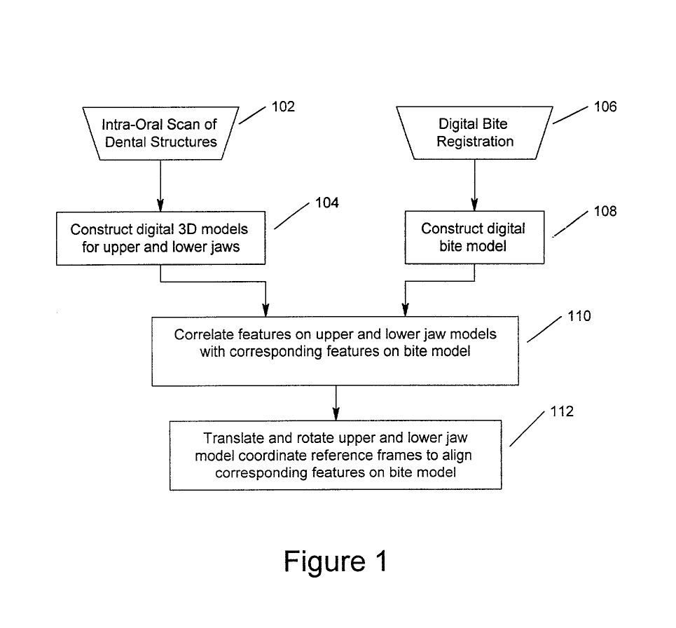

Referring to FIG. 1, one embodiment utilizes digital 3D dental models and an image of the facial bite to determine bite registration. First, an intra-oral scan of a dental structure is taken (step 102), and a 3D model of the upper and lower jaws is constructed (step 104). In parallel or in seriatim, a digital bite registration is performed (step 106), and a digital bite model is constructed (step 108). From steps 104 and 108, features on the upper and lower jaw models are correlated with corresponding features on the bite model (step 110). Further, upper and lower jaw coordinate reference frames are translated and rotated to align the jaws with corresponding features on the bite model (step 112).

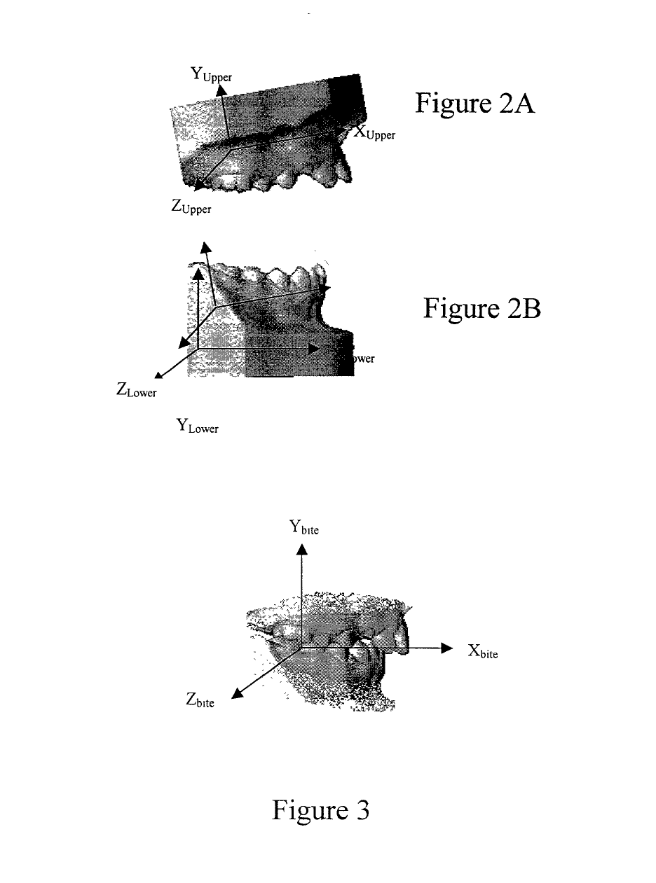

Referring to FIGS. 2A-2B and FIG. 3, one embodiment of this invention utilizes digital 3D dental models of the upper and lower jaws created from separate scans of each jaw with the jaw in an open position (FIG. 2A and 2B) and a third 3D model created from a scan of the dental structure with the jaw in a closed position (FIG. 3). The digital 3D dental models (FIG. 2) are acquired by use of an intra oral scanner that captures and processes images of the dental structures and generates a 3D surface contour of the scanned structures. Typically the scanned structures include both the anterior and posterior teeth surfaces and a region of gingiva adjacent to the base of the teeth. The upper jaw scan may also include the palate.

The surface contours of the 3D models (FIGS. 2A-2B) are defined by a matrix of points, and for a Cartesian coordinate system, the x, y and z value assigned to the point represents a location that is on the surface contour of the scanned dental structure. As shown in FIGS. 2A-2B, the coordinate reference frame for the upper jaw model and the lower jaw model are typically in an arbitrary and unknown alignment with respect to each other. This difference in the coordinate reference frame alignment reflects that the upper and lower jaw 3D models were obtained independently and in each case the jaw was sufficiently open to provide the intra-oral scanner with access to the posterior surfaces of the dental structures.

The 3D model obtained with the jaws closed (FIG. 3) may also be acquired by use of an intra-oral scanner that captures and processes images of the dental structures and generates a 3D surface contour of the scanned structures. In this case, the 3D model contains some features from both the upper and the lower jaw structures, and the same coordinate frame of reference is used to locate the surface contour of these features. However, because the jaws are closed, the 3D model depicted in FIG. 3 is an incomplete facade since only anterior dental structures accessible with the jaws closed can be scanned and utilized to create the model.

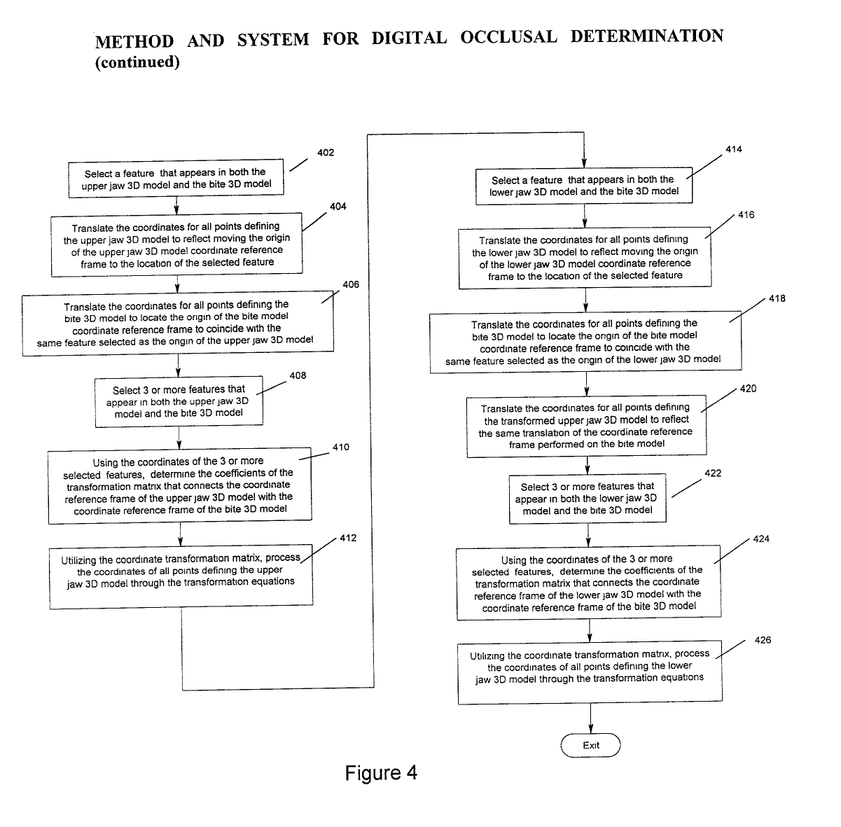

One embodiment of this invention utilizes the method of FIG. 4 to determine the alignment of upper and lower jaw 3D models for the closed jaw position. First, a feature appearing in both the upper jaw model and the bite 3D model is selected (step 402). Coordinates for points defining the upper jaw are translated to reflect the moving of the origin of the upper jaw model coordinate reference frame to the location of the selected feature (step 404). Next, coordinates for points defining the bite model are translated to reflect the moving of the origin of the bite model coordinate reference frame to the location of the selected feature (step 406). Three or more features are then selected (step 408). Using the coordinates of the selected features, the coefficients of a transformation matrix are determined (step 104). The coefficients of the transformation matrix are then used to process the coordinates of points defining the upper jaw 3D model through the transformation equations (step 412).

A feature that appears in both the lower jaw model and the bite 3D model is selected (step 414). Coordinates for points defining the lower jaw are translated to reflect the moving of the origin of the lower jaw model coordinate reference frame to the location of the selected feature (step 416). Next, coordinates for points defining the bite model are translated to reflect the moving of the origin of the bite model coordinate reference frame to the location of the selected feature on the lower jaw (step 418).

Coordinates for points defining the transformed upper jaw model are translated to reflect the moving of the origin of the bite model coordinate reference frame to the location of the selected feature (step 420). Three or more features are then selected (step 422). Using the coordinates of the selected features, the coefficients of a transformation matrix are determined (step 424). The coefficients of the transformation matrix are then used to process the coordinates of points defining the lower jaw 3D model through the transformation equations (step 426).

The application of the process of FIG. 4 to exemplary data is discussed next. Once the data files representing the surface contours for the three models depicted in FIGS. 2A-2B and FIG. 3 have been generated, one dental structure feature that appears on both the upper jaw 3D model (FIG. 2A) and the bite 3D model (FIG. 3) is selected. This selected feature will be referred to as Feature 1. The origin of the upper jaw coordinate reference frame (FIG. 2A) is moved to correspond with the location of Feature 1by subtracting the x, y, and z values of Feature 1's coordinates (FIG. 2A) from the coordinates of all other points in the upper jaw 3D model. The origin of the bite model coordinate reference frame (FIG. 3) is also moved to correspond with the location of Feature 1 by subtracting the x, y, and z values of feature 1's coordinates (as measured in the FIG. 3 coordinate reference frame) from the coordinates of all other points in the bite 3D model. Once the upper jaw and bite model coordinate reference frames have been translated, Feature 1 is located at the origin of both the upper jaw model and bite model coordinate reference frames.

Three or more additional features are selected that appear in both the upper jaw 3D model and the bite 3D model. This identification and correlation of the three or more features observable in the two models may be accomplished manually by an operator selecting features on a display or automatically by a computer using standard image registration algorithms well known in the art. The selected feature's x, y and z coordinates as measured in the translated upper jaw 3D model and the x, y and z coordinates of the same features as measured in the bite 3D model are used together to determine the coefficients of the transformation formula connecting the two coordinate reference frames. The transformation formula is defined by the following equations.

x′=x(i·i′)+y(j·i′)+z(k·i′)

y′=x(i·j′)+y(j·j′)+z(k·j′)

z′=x(i·k′)+y(j·k′)+z(k·k′)

Where:

x, y, z are the coordinates of a selected feature in the coordinate reference frame of the translated upper jaw 3D model;

x′, y′, z′ are the coordinates of a selected feature in the coordinate reference frame of the translated bite 3D model;

i , j, k are the unit vectors of the x, y, and z axis of the coordinate reference frame of the translated upper jaw 3D model;

i′, j′, k′ are the unit vectors of the x, y, and z axis of the coordinate reference frame of the translated bite 3D model; and

(i·i′), (j·i′), . . . (k·k′) are the vector dot products between the various axis of the two coordinate systems

The pairs of x, y, z and x′, y′, z′ for each selected feature are used in the transformation equations to construct the 9 or more equations needed to determine the nine unknown coefficients of a transformation matrix. Once the values of the nine dot product coefficients have been determined, these coefficients are used to create the transformation matrix Tᵤₚₚₑᵣ that connects coordinates in the upper jaw 3D model with the corresponding coordinates in the bite 3D model.

$${T}_{upper} = [ \begin{matrix}( i \cdot {i}^{′} ) & ( j \cdot {i}^{′} ) & ( k \cdot {i}^{′} ) \\ ( i \cdot {j}^{′} ) & ( j \cdot {j}^{′} ) & ( k \cdot {j}^{′} ) \\ ( i \cdot {k}^{′} ) & ( j \cdot {k}^{′} ) & ( k \cdot {k}^{′} )\end{matrix} ]$$

The coordinates for all points used to define the upper jaw 3D model are then transformed to correspond with the coordinate reference frame of the bite 3D model using the following equation.

P(n)_{upper—}bite 32 P(n)_{upper—}jaw×Tᵤₚₚₑᵣ

Where:

P(n)upper_bite=a vector with the x, y, z coordinates of the nth point of the upper jaw 3D model after transformation into the coordinate reference frame of the bite 3D model; and

P(n)upper_jaw=a vector with the x, y, z coordinates of the nth point of the upper jaw 3D model in the coordinate reference frame of the upper jaw 3D model

The alignment of the upper jaw 3D model (FIG. 2A) with the lower jaw 3D model (FIG. 2B) continues now by translating and transforming the lower jaw model into the bite 3D model coordinate reference frame which is now also used by the upper jaw 3D model.

One dental structure feature that appears on both the lower jaw 3D model (FIG. 2B) and the bite 3D model (FIG. 3) is selected. This selected feature will be referred to as Feature 2. The origin of the lower jaw coordinate reference frame (FIG. 2B) is moved to correspond with the location of Feature 2 by subtracting the x, y, and z values of Feature 2's coordinates (FIG. 2B) from the coordinates of all other points in the lower jaw 3D model. The origin of the bite model coordinate reference frame (FIG. 2A) is also moved to correspond with the location of Feature 2 by subtracting the x, y, and z values of Feature 2's coordinates (as measured in the FIG. 2A coordinate reference frame) from the coordinates of all other points in the bite 3D model. To maintain the alignment of the transformed upper jaw 3D model, the same translation must be performed by subtracting the x, y, and z values of Feature 2's coordinates (as measured in the bite 3D model of FIG. 3's coordinate reference frame) from the coordinates of all points in the transformed upper jaw 3D model. Once the lower jaw and bite model coordinate reference frames have been translated, Feature 2 is located at the origin of both the lower jaw model and bite model coordinate reference frames.

Three or more additional features are selected that appear in both the lower jaw 3D model and the bite 3D model. This identification and correlation of the three or more features observable in the two models may be accomplished manually by an operator selecting features on a display or automatically by a computer using standard image registration algorithms well known in the art. The selected feature's x, y and z coordinates as measured in the translated lower jaw 3D model and the x, y and z coordinates of the same features as measured in the bite 3D model are used together to determine the coefficients of the transformation formula connecting the two coordinate reference frames. The transformation formula is defined by the following equations:

x′=x(i·i′)+y(j·i′)+z(k·i′)

y′=x(i·j′)+y(j·j′)+z(k·j′)

z′=x(i·k′)+y(j·k′)+z(k·k′)

Where:

x, y, z are the coordinates of a selected feature in the coordinate reference frame of the translated lower jaw 3D model;

x′, y′, z′ are the coordinates of a selected feature in the coordinate reference frame of the translated bite 3D model;

i, j, k are the unit vectors of the x, y, and z axis of the coordinate reference frame of the translated lower jaw 3D model;

i′, j′, k′ are the unit vectors of the x, y, and z axis of the coordinate reference frame of the translated bite 3D model; and

(i·i′), (j·i′), . . . (k·k′) are the vector dot products between the various axis of the two coordinate systems

The pairs of x, y, z and x′, y′, z′ for each selected feature are used in the transformation equations to construct the 9 or more equations needed to determine the nine unknown coefficients of transformation matrix. Once the values of the nine dot product coefficients have been determined, these coefficients are used to create the transformation matrix T_{lower} that connects coordinates in the lower jaw 3D model with the corresponding coordinates in the bite 3D model.

$${T}_{lower} = [ \begin{matrix}( i \cdot {i}^{′} ) & ( j \cdot {i}^{′} ) & ( k \cdot {i}^{′} ) \\ ( i \cdot {j}^{′} ) & ( j \cdot {j}^{′} ) & ( k \cdot {j}^{′} ) \\ ( i \cdot {k}^{′} ) & ( j \cdot {k}^{′} ) & ( k \cdot {k}^{′} )\end{matrix} ]$$

The coordinates for all points used to define the lower jaw 3D model are then transformed to correspond with the coordinate reference frame of the bite 3D model using the following equation:

P(n)_{lower—}bite=P(n)_{lower—}jaw×T_{lower}

Where:

P(n)_{lower—bite}=a vector with the x, y, z coordinates of the nth point of the lower jaw 3D model after transformation into the coordinate reference frame of the bite 3D model; and

P(n)_{lower—jaw}=a vector with the x, y, z coordinates of the nth point of the lower jaw 3D model in the coordinate reference frame of the lower jaw 3D model

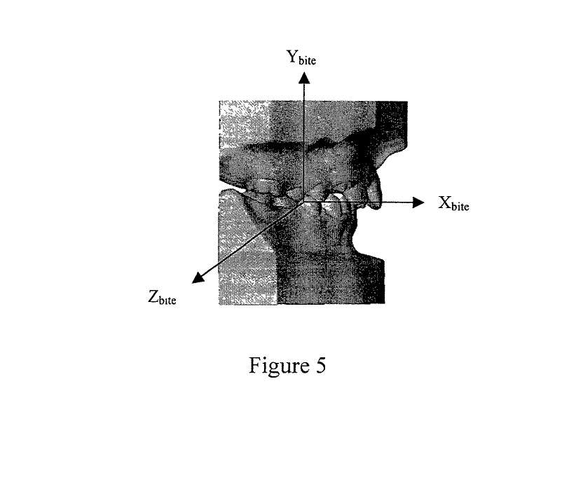

The alignment of the upper jaw 3D model (FIG. 2A) with the lower jaw 3D model (FIG. 2B) is now complete and the coordinate reference frame for each of the points used to define the surface contour of the upper jaw 3D model (FIG. 2A) is now the same as the coordinate reference frame for each of the points used to define the surface contour of the lower jaw 3D model (FIG. 2B). FIG. 5 illustrates this alignment of the coordinate reference frame for the upper and lower 3D models.

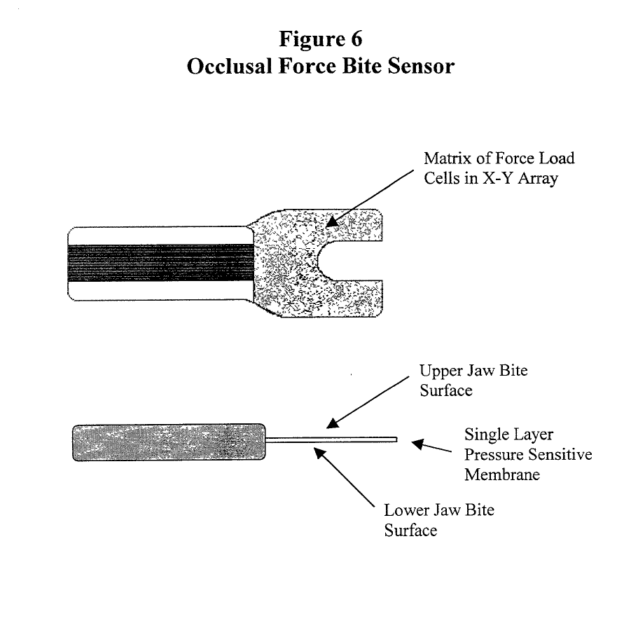

Another embodiment of the invention utilizes an occlusal bite sensor array to develop a common coordinate reference frame for aligning the upper jaw (FIG. 2A) and lower jaw (FIG. 2B) 3D models. An exemplary occlusal bite sensor array detects points on a grid where the sensor is being contacted on opposing sides by teeth surfaces or other contacting points, as shown in FIG. 6. One embodiment of the bite sensor uses an array of resistive-membrane position sensors, which respond to pressure. An alternative embodiment uses capacitive sensing, in which the location of teeth over a sensing device is determined through variations in capacitance under and around the location of the teeth. In this embodiment, a matrix of row and column electrodes detect, for example, either the capacitance between row and column electrodes or the effective capacitance to virtual ground. Yet other embodiments use surface acoustic wave devices, sensors based on strain gages or pressure sensors, and optical sensors.

In another embodiment, the sensor array is commercially available from Tekscan and is used in Tekscan's T-Scan occlusal analysis system. The scanner of FIG. 6 extends the utility of an occlusal force sensor by using the positional information associated with the force distribution from the occlusal bite sensor to determine the bite alignment for the digital models of the upper and lower jaws. As discussed in U.S. Pat. No. 4,856,993, issued Maness, et al., the contact sensor includes two sets of parallel electrodes which are each formed on a thin, flexible supporting sheet. The electrodes are separated by a thin, pressure-sensitive resistive coating. Two such electrode structures are oriented at approximately right angles to create a grid where the intersecting electrodes cross separated by the resistive coatings. Several arrangements of resistive coating over electrodes are disclosed. In the absence of an external force, the material between the electrodes sets provides a high resistance between intersecting electrodes. The resistance between electrode intersections changes as pressure on opposite sides of the intersection changes. The sensor output is dynamic in that the resistance will vary as external pressure is repeatedly applied and removed. A circuit measures the resistance between each electrode intersection and provides an output representative of the opposing forces at the intersection.

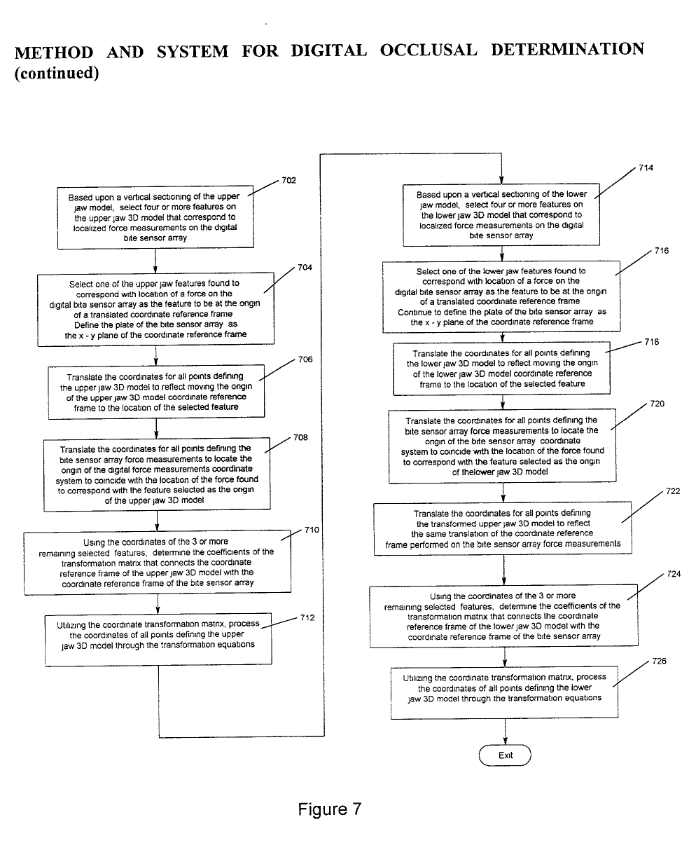

FIG. 7 describes the alignment process for this embodiment of the invention. The alignment process utilizing the bite sensor array proceeds in a manner similar to that previously described for the bite 3D model derived from images captured during an intra-oral scan. In this case the selection of the model features to use for aligning the coordinate reference frames is based upon the correlation of an upper jaw or lower jaw dental structure feature, such as the tip of a tooth, with the corresponding force local maximum measured by the bite sensor array (step 702). Once the feature-force correlations have been established, the coordinates of the forces measured by the bite sensor array are used to perform the coordinate reference frame translations and transformations previously described. First, an upper jaw feature corresponding with one of the localized forces is selected to represent the origin of a new coordinate reference frame (step 704). Next, coordinates for points defining the upper jaw are translated to reflect the moving of the origin of the upper jaw model coordinate reference frame to the location of the selected feature (step 706). Next, coordinates for points defining the bite model are translated to reflect the moving of the origin of the digital bite model coordinate reference frame to the location of the selected feature (step 708). Three or more additional feature-force pairs are then selected and using the coordinates of the selected features, the coefficients of a transformation matrix are determined (step 710). The coefficients of the transformation matrix are then used to process the coordinates of points defining the upper jaw 3D model through the transformation equations (step 712).

Features on the lower jaw, such as the tip of a tooth, are identified that correspond with force local maximum measured by the bite sensor array (step 714). One of the lower jaw features found to correspond with a force measurement is selected (step 716). Coordinates for points defining the lower jaw are translated to reflect the moving of the origin of the lower jaw model coordinate reference frame to the location of the selected feature (step 718). Next, coordinates for points defining the digital bite sensor force measurements are translated to reflect the moving of the origin of the digital bite sensor array coordinate reference frame to the location of the force corresponding with the selected feature on the lower jaw (step 720).

Coordinates for points defining the transformed upper jaw model are translated to reflect the moving of the origin of the bite sensor array coordinate reference frame to the location of the selected feature (step 722). Three or more features-force pairs are then selected and using the coordinates of the selected features, the coefficients of a transformation matrix are determined (step 724). The coefficients of the transformation matrix are then used to process the coordinates of points defining the lower jaw 3D model through the transformation equations (step 726).

Just as before, the result is that the coordinate reference frame for each of the points used to define the surface contour of the upper jaw 3D model (FIG. 2A) is now the same as the coordinate reference frame for each of the points used to define the surface contour of the lower jaw 3D model (FIG. 2B).

One drawback to determining the bite alignment for the digital models using a conventional occlusal bite sensor is that there is an uncertain degree of cross correlation of the measured forces between the dental structures of the upper and lower jaws. Exemplary bite sensor arrays such as the Tekscan T-Scan use a thin sensor between the two jaws to measure the pressure distribution between the two surfaces and it is intended that the measured forces reflect the combined influence of opposing dental structures on both jaws. While the error that might be introduced by this cross correlation may be reduced by selecting a larger number of feature-force pairs to use for determining the coefficients of the coordinate translation and transformation matrix, an alternative embodiment of the present invention utilizes a bite sensor array that isolates the upper and lower jaw forces and thereby reduces the cross correlations of the local force measurements.

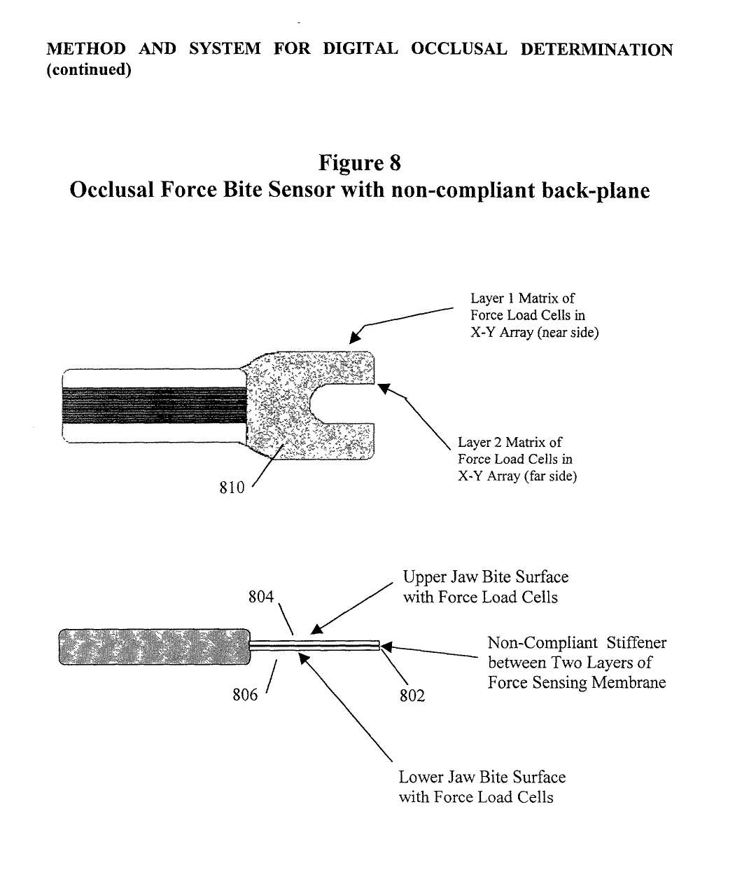

FIG. 8 shows an embodiment of a sensor whereby the localized forces caused by dental structures on each jaw are isolated by utilizing a non-compliant back-plane or stiffener 802 located between an upper jaw bite sensor array 804 and a lower jaw bite sensor array 806 contained in the same package. In this manner, the force exerted upon each load cell 810 is localized to dental structures on the respective jaw since the non-compliant backing acts as a force sink and integrator for the opposing jaw. To achieve a near full occlusal measurement with the bite sensor array, and thereby minimize errors in determining the proper bite alignment, the stack height of the sensor and non-compliant backing is kept as thin as practical and ideally under 0.5 mm.

In one embodiment, the sensor includes a ground plane using copper or other suitable conductor. A layer of flexible material such as silicone or other suitably soft material is disposed above the ground plane. The flexible material allows sufficient displacement or compression to mechanically vary the distance between the traces and the ground plane, thus varying the capacitance. An X-Y matrix is positioned above the flexible material. The X-Y matrix has a layer of Y traces arranged as a plurality of columns, an insulating layer, and a layer of X traces arranged as a plurality of rows. The insulating layer can be a rigid fiberglass substrate such as that used for printed circuit boards.

During operation, the teeth biting on the insulating layer causes a sufficient change in the capacitance of the X and Y layer traces (with respect to ground) of the matrix to be detectable with conventional sensing circuitry. When the patient bites the plate, the capacitance of the layer changes, since the ground plane may be thought of as one plate of a capacitor, while the traces form the other plate. The changing capacitances can be brought about by one or the other, or combination of, varying the distance between the two capacitive plates, and varying the dielectric value of the insulating layer. That change in capacitance creates, after appropriate signal manipulation, a bite profile.

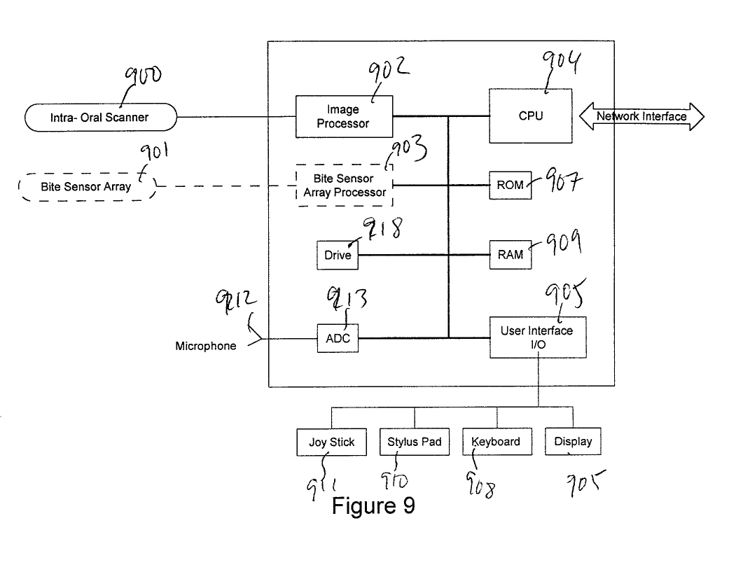

Referring to FIG. 9, a system block diagram depicting the instrumentation used in scanning teeth and other dental structure images and in generating 3D models, will facilitate a general understanding and appreciation of the disclosed method and apparatus. An intra-oral scanner 900 is adapted to be placed inside the mouth of the patient (intra-oral cavity). The intra-oral scanner 900 captures images of various dental structures in the mouth and communicates this information with a 3D image processor 902. The image processor 902 in turn can communicate with a processor 920. In one implementation, the intra-oral scanner 900 is embedded in an intra-oral structure, such as a mouthpiece. An image aperture is provided to capture images of the dental structures. The image aperture can be an objective lens followed by relay lens in the form of a light-transmission cable such as a fiber optic cable to transmit images of the dental structures along a pre-selected distance to a camera. The intra-oral scanner 900 contains components that support one or more of the following functions: 1) illuminate the dental structure to be imaged; 2) digitally image a dental structure from different aspects; and 3) reposition both the illumination and imaging apertures so as to traverse the entire intra-oral cavity. More details of the scanner 900 are disclosed in co-pending applications entitled “METHOD AND SYSTEM FOR IMAGING AND MODELING DENTAL STRUCTURES” with U.S. Ser. No. 09/696,065, filed Oct. 25, 2000 and U.S. Ser. No. 09/___,___, filed ___, 2000, the contents of which are hereby incorporated by reference.

The 3D image engine 902 also assesses the quality of the acquired digital model and can display to the user highlighted regions where the model reflects an anomalous surface contour, or where uncertainties in the calculated estimate of the surface contour exceeds a user specified limit. The output of the 3D image engine 902 is provided to a display driver for driving a display or monitor 905. The 3D image processor 902 communicates with a processor 904. Correspondingly, a bite sensor array 901 is connected to a bite sensor processor 903, and the output of the bite sensor processor 903 is provided to the processor 904.

The processor 904 is connected to ROM 907, RAM 909, and an I/O interface 905. The interface 905 receives commands from a user through a mouse 906, a keyboard 908, or a stylus pad 910 or joystick 911. Additionally, a microphone 912 is provided to capture user voice commands or voice annotations. Sound captured by the microphone 912 is provided to an analog to digital converter 913 which is connected to the processor 904. The processor 904 is connected to a data storage unit 918 for storing files.

While viewing the 3D representation of the digital model, the user may use mouse 906, keyboard 908, stylus pad 910, joy stick 911 or voice inputs to control the image display parameters on the monitor 905, including, but not limited to, perspective, zoom, feature resolution, brightness and contrast. Regions of the 3D representation of the digital model that are highlighted by the CAD system as anomalous are assessed by the user and resolved as appropriate. Following the user assessment of the 3D image of the digital working model, the dental CAD system provides the user with tools to archive a watermarked file of the 3D model. The above system supports a rapid imaging of dental structures in such a way, and with sufficient resolution such that the acquired images can be processed into accurate 3D models of the imaged dental structures. The images and models can be processed on a computer to provide dental diagnosis and to support the specification and manufacture of dental prosthetics such as bridgeworks, crowns or other precision moldings and fabrications. The computer can transmit data representing a set of dental images and models over a wide area network such as the Internet to support activity such as professional consults or insurance provider reviews and the images and models may be electronically archived for future reference.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method for integrating bite registration data with a digital model of an upper jaw and a lower jaw, comprising:
a) determining one or more features on the bite registration data and the digital model;
b) correlating features on the upper and lower jaws with features on the bite registration data; and
c) aligning the digital model of the upper and lower jaws.

2. The method of claim 1, wherein the bite registration data is used to show a partial occlusion.

3. The method of claim 1, wherein the bite registration data is used to show a full occlusion.

4. The method of claim 1, wherein the digital model represent partial jaws.

5. The method of claim 1, wherein the digital model represent full jaws.

6. The method of claim 1, wherein the features include points on the jaws and the bite registration data.

7. The method of claim 1, further comprising constructing a digital model for the upper and lower jaws.

8. The method of claim 1, further comprising constructing a digital bite model.

9. The method of claim 8, wherein the constructing the digital bite model further comprises biting into an array of sensors.

10. The method of claim 8, wherein the constructing the digital bite model further comprises capturing images of upper and lower jaw dental structures with the jaws closed.

11. A system for integrating bite registration data with a digital model of an upper jaw and a lower jaw, comprising:
a) means for determining one or more features on the bite registration data and the digital model;
b) means for correlating features on the upper and lower jaws with features on the bite registration data; and
c) means for aligning the digital model of the upper and lower jaws.

12. The system of claim 11, wherein the bite registration data is used to show a partial occlusion.

13. The system of claim 11, wherein the bite registration data is used to show a full occlusion.

14. The system of claim 11, wherein the digital model represent partial jaws.

15. The system of claim 11, wherein the digital model represent full jaws.

16. The system of claim 11, wherein the features include points on the jaws and the bite registration data.

17. The system of claim 11, further comprising means for constructing a digital model for the upper and lower jaws.

18. The system of claim 11, further comprising means for constructing a digital bite model.

19. The system of claim 18, wherein the means for constructing the digital bite model further comprises an array of sensors.

20. The system of claim 18, wherein the means for constructing the digital bite model further comprises an intra-oral scanner that captures images of dental structures on the upper and lower jaws.
